(19) United States
(12) Patent Application Publication
(10) Pub. No.: US 2021/0126238 A1
(43) Pub. Date: Apr. 29, 2021

(54) Method of Manufacturing Electrode Materials by Using Treated Carbon Nanotube Tapes

(71) Applicants: Ali Sadeghi, Atherton, CA (US); Yuri Vorobyev, San Carlos, CA (US); Gene Kristul, San Francisco, CA (US)

(72) Inventors: Ali Sadeghi, Atherton, CA (US); Yuri Vorobyev, San Carlos, CA (US); Gene Kristul, San Francisco, CA (US)

(21) Appl. No.: 16/664,783

(22) Filed: Oct. 25, 2019

(51) Int. Cl. H01M 4/04; H01M 4/583; H01M 4/1393; H01M 4/133; H01G 11/36

(52) U.S. Cl. CPC H01M 4/0471; H01M 4/0445; H01M 4/583; H01M 2004/021; H01M 4/133; H01G 11/36; H01M 4/1393

(57) ABSTRACT

A method of manufacturing porous electrodes based on the use of a CNT tapes is proposed. The pore size of the CNT tape material is regulated by using chemical reactions of active gases with carbon on the surfaces of the pores so that when gaseous reaction products leave the pores, the pore sizes increase, and when solid reaction products precipitate on the pore walls, the pores decrease. By selecting conditions for the chemical interaction of the active components, it is possible to achieve optimal pore sizes due to their increase or decrease. Optimal pore sizes are understood to mean sizes that will make it possible to obtain batteries or super capacitors with improved characteristics.

### FIELD OF THE INVENTION

The present invention relates to the field of electrodes such as anodes used in lithium batteries, lithium-ion batteries (LIBs), and in electrodes super-capacitors (Electrochemical Double-Layer Capacitors (EDLCs)). More specifically, the invention relates to a method of manufacturing electrodes that incorporate treated carbon nanotube tapes.

### DESCRIPTION OF THE PRIOR ART

The electrodes made of carbon nanostructures allow creating more powerful and long-lasting batteries LIB, and graphene wall-controlled nano-pores protect them from destruction after many charge and discharge cycles.

Development of a new anode material for LIB with adjustable size and pore properties, allows to significantly increase the energy efficiency of lithium-ion batteries, including those used in film applications.

A trend in the development of LIBs and EDLCs depend from electrode quality that defines increase in capacitance, prolongation of service life, optimization of structure, decrease of fire risk and reduction in the manufacturing cost.

The materials that nowadays are used in LIB are subject to deterioration during the charging-discharging cycles. Because of such repetitive cycles, an inactive layer forms around the material and degrades the battery performance. In this process, an important role belongs to material porosity.

In EDLCs, on the other hand, electrode porosity is an important factor in increasing capacitance and decreasing leakage currents.

In this art, the porosity is often characterized by the porosity spectrum or differential pore volume distribution. This term defines the pore volume in relation to the pore size. This is because just total porosity itself does not say anything about the pore size(s), and an average pore size does not say anything about the representatively of such a size. Only the pore-size distribution brings information that is more complete.

A solution of these problems is a major goal in the development of processes for manufacturing reliable battery component, in particular electrodes such as anodes and cathodes.

Attempts to solve the above problems are disclosed in multiple patents some of which are shown below.

For example, U.S. Pat. No. 9,455,469 granted on Sep. 27, 2016 to Y. Wang, et al. discloses a rechargeable magnesium-ion cell having a high-capacity cathode. A magnesium-ion cell contains a cathode made from a carbon or graphitic as an active material having a surface area to capture and store magnesium. The cathode forms a meso-porous structure having a pore size from 2 nm to 50 nm and a specific surface area greater than 50 m²/g. The anode acts as a current collector alone or in a combination of the anode current collector with an anode active material. A porous separator is disposed between the anode and the cathode. An electrolyte is in ionic contact with the anode and the cathode. The anode is provided with a magnesium ion source for obtaining an open circuit voltage from 0.5 volts to 3.5 volts when the cell is made. Porosity is controlled by chemical and thermal treatment for creating meso-scaled pores (2-50 nm) to enable the interior structure being accessed by Mg ion-carrying electrolyte.

U.S. Pat. No. 9,742,001 granted to A. Zhamu, et al. on Aug. 22, 2017 discloses graphene foam-protected anode active materials for lithium batteries. A lithium-ion battery anode layer is an anode active material embedded in pores of a solid graphene foam composed of multiple pores and pore walls, wherein (a) the pore walls contain a pristine graphene material having essentially no (less than 0.01%) non-carbon elements or a non-pristine graphene material having 0.01% to 5% by weight of non-carbon elements; (b) the anode active material is in an amount from 0.5% to 95% by weight based on the total weight of the graphene foam and the anode active material combined, and (c) some of the multiple pores are lodged with particles of the anode active material and other pores are particle-free, and the graphene foam is sufficiently elastic to accommodate volume expansion and shrinkage of the particles of the anode active material during a battery charge-discharge cycle to avoid expansion of the anode layer. Preferably, the solid graphene foam has a density from 0.01 to 1.7 g/cm³, a specific surface area from 50 to 2,000 m²/g, a thermal conductivity of at least 100 W/mK per unit of specific gravity, and/or an electrical conductivity no less than 1,000 S/cm per unit of specific gravity. The manufacturing process involves the use of non-carbon elements as a blowing agent. The use of the blowing agent can provide added flexibility in regulating or adjusting the porosity level and pore sizes for a desired application.

U.S. Pat. No. 8,951,451 granted to K. Muramatsu, et al. on Feb. 10, 2015 discloses carbon material and method for producing the same. A properly pre-baked filler is sealed in a graphite vessel and is subsequently subjected to hot isostatic pressing (HIP) treatment, thereby allowing gases such as hydrocarbon and hydrogen to be generated from the filler and precipitating vapor-phase-grown graphite around and inside the filler using the generated gases as a source material, and thereby, an integrated structure of carbide of the filler and the vapor-phase-grown graphite is produced. In addition, nano-carbon materials are produced selectively and efficiently by adding a catalyst or adjusting the HIP treating temperature. In the case of producing electrode materials for primary batteries and secondary batteries such as lithium ion batteries, capacitors and fuel cells, a porous graphite block adjusted to a proper open pore ratio and pore size distribution by the above-mentioned method is cut into a sheet of 50 to 1000 μm by electric discharge machining, or water jetting, or with a multi-wire saw, thereby enabling a slurry preparation step and a coating step to be eliminated. A lithium ion battery, a capacitor, a primary battery, a suitable open porosity, the porous graphite block is adjusted to the pore size distribution.

U.S. Pat. No. 8,273,267 issued to R. Akagi, et al. on Oct. 22, 2013 discloses a method for producing positive electrode active material for battery which can realize easy regulation of pore size in porosity formation of a positive electrode active material and is less likely to undergo hindrance of ion conduction caused by residues and, thus, can realize excellent high-rate discharge characteristics. The invention also relates to a method for producing a composition for a battery using the positive electrode active material for the battery. This method includes: a step 1 of firing a mixture of a raw material for the positive electrode active material and carbon particles to remove the carbon particles; and a step 2 of milling and classifying a fired body obtained in the step 1.

The positive electrode active material sintered body for a battery of the present invention is a positive electrode active material sintered body for a battery satisfying the following requirements (I) to (VII): (I) fine particles in a positive electrode active material are sintered to constitute the sintered body; (II) a peak pore diameter which provides a maximum differential pore volume value in a pore diameter range of 0.01 to 10 μm in a pore distribution is 0.3 to 5 μm; (III) a total pore volume is 0.1 to 1 cc/g; (IV) an average particle diameter is not less than the peak pore diameter and not more than 20 μm; (V) any peak, which provides a differential pore volume value of not less than 10% of the maximum differential pore volume value, is not present on a smaller pore diameter side than the peak pore diameter in the pore distribution; (VI) a BET specific surface area is 1 to 6 m²/g; and (VII) a full width at half maximum of a strongest X-ray diffraction peak is 0.13 to 0.2.

US Patent Application Publication No. 20180138498 published on May 17, 2018 (Inventors: A. Zhamu, et al.) discloses a surface-mediated lithium ion-exchange energy storage device that contains a cathode and anode which function as cathode and anode active material shaving a surface areas capable of capturing and storing lithium. The cathode and anode are separated by porous separator. The device further includes a lithium-containing electrolyte, which is in a physical contact with both electrodes. The anode active material or the cathode active material, is a pure graphene, fluoride graphene hydroxide graphene, nitride graphene, boron doped graphene, or the like. It is possible to form a mesoporous structure having a desired pore size range (e.g., slightly 2 nm greater). This size range seems to become conductive contact with a lithium-containing electrolyte generally used.

U.S. Pat. No. 6,697,249 issued on Feb. 24, 2004 to Yurii Maletin, et al. discloses a supercapacitor and a method of manufacturing such a supercapacitor. The supercapacitor contains an electric double layer capacitor including at least one pair of polarizable electrodes connected to current collectors, a separator made of ion-permeable but electron-insulating material interposed between the electrodes in each pair of electrodes, and a liquid electrolyte. The electrodes include a layer of carbon particles having a narrow distribution of nano-pores therein, the pore sizes of the nano-pores being adapted to fit the ion sizes of the electrolyte.

### SUMMARY OF THE INVENTION

The invention relates to a method of manufacturing porous electrodes based on the use of a CNT tapes and applicable, e.g., to carbon-ion supercapacitors containing a non-aqueous solution of an electrolyte based on, for example, 1-methyl-1-propylpiperidinium bis(trifluoromethanesulfonyl) as well as imide oxides of Li, Al, Ti, Mo, Ta, V, Mn, etc., embedded in a carbon matrix.

According to the invention, pore sizes can be regulated by using chemical reactions of active gases (oxygen, hydrogen, ethylene, etc.) with the walls of a carbon matrix, such as a CNT tape, film, fibers, etc. Because of these reactions, carbon can pass into a gaseous state from the pore walls in the form of chemical compounds (CO, CH4, CH2, CO2, C2H4, etc.) and leave the pores, or, inversely, can precipitate in the form of solid carbon-containing compounds on the pore walls. If carbon leaves the pore walls in the form of a gaseous carbon-containing compound, then the pore sizes increase, and if solid carbon-containing reaction product precipitates, then the pores decrease. Thus, it is possible to optimize porosity of the matrix for the required purposes. By selecting the conditions for the chemical interaction of the aforementioned components, it is possible to achieve optimal pore sizes due to their increase or decrease. Optimal pore sizes are understood to mean sizes that will make it possible to obtain batteries or super capacitors with improved characteristics.

### BRIEF DESCRIPTION OF THE DRAWING

FIG. 1 is a flowchart of an exemplary sequence of CNT tape treatment operations in accordance with the method of the invention.

### DETAILED DESCRPTION OF THE INVENTION

The present invention relates to the field of electrodes such as anodes used in lithium batteries, lithium-ion batteries (LIBs), and in electrodes super-capacitors (Electrochemical Double-Layer Capacitors (EDLCs)). More specifically, the invention relates to a method of manufacturing electrodes that incorporate pretreated carbon nanotube tapes.

A main novelty of the present invention is obtaining of an anode material (for LIBs) and electrode material (for EDLCs) with the desired properties. The invention is based on the use of a porous matrix with synthesized carbon structures having very large surface area that is formed by treating a carbon nanotube tape (CNT) under low vacuum with admixture of oxygen, or carbon monoxide, or hydrogen in admixture with an inert gas (e.g., argon, helium).

More specifically, the invention relates to a method of manufacturing porous electrodes based on a use of a CNT tape and applicable, e.g., to carbon-ion supercapacitors containing a non-aqueous solution of an electrolyte based on, for example, 1-methyl-1-propylpiperidinium bis(trifluoromethanesulfonyl) as well as imide oxides of Li, Al, Ti, Mo, Ta, V, Mn, etc., embedded in a carbon matrix.

CNT tapes suitable for the present invention are conventional commercially produced items. The CNT tapes may be of different types. For example, the CNT per se can be formed into a tape, sheet, ribbon, etc. Commercially, CNT tapes are produced by different companies. DexMat Co., Houston, Tex., produces homogenous CNT films, tapes and sheets, which have the following properties: film thickness—20 to 60 μm; conductivity—2 to 6 MS/m; strength—200 MPa to 600 MPa; density—1 to 3 g/cm³. The company produces CNT tape with a width in the range of 1 to 3 cm.

Another popular manufacturer of the TNC materials is Nanocomp Technologies, Inc., Merrimack, N.H. The company produces Miralon sheet and tape products, which are pure CNT non-woven materials that can be used in a variety of applications to lighten and enhance a product or system performance.

There are no special limitations to the CNT tapes dimension, and the tapes may have the shape and dimensions in accordance with the electrode to be prepared by the method of the invention. For evaluation, it is recommended to prepare samples from tapes having a width, e.g., of 10 to 20 mm, a thickness of 20 to 60 μm, and a length of 10 to 60 mm.

A CNT tape electrode of the invention for LIBs and EDLCs consists of a thin highly conductive substrate made from a metal foil of copper, aluminum, or the like, which supports a specially pretreated porous CNT tape bonded to the conductive support by a conductive binder. The CNT tape is pretreated in a manner described below.

A conductive binder is used for attaching the porous electrode body of the invention to a substrate such as a thin metal foil, or another substrate material. The same binder is used in the manufacture of super capacitors or batteries for attaching the ion-lithium anodes and cathodes to respective structural components of the capacitors and batteries, e.g., for attaching to a separator that isolates the anode from the cathode, etc.

The conductive binder is prepared on the bases of a polymer, e.g., poly(tetrafluoroethylene) (PTFE) or poly(vinylidenedifluoride) (PVDF) mixed with highly conductive carbon nanoparticles. The use of a carbon-polymer mixture binder eliminates the need for conductive additives. Due to their flexibility, the polymer binders accommodate a battery electrode's expansion and contraction during charge/discharge. Examples of such binders are chemically and mechanically stable materials IB-2643, IB-2643A, IB-3279 developed by the Berkeley Lab.

The non-aqueous solution of an electrolyte may be represented, e.g., by 1-methyl-1-propylpiperidinium bis(trifluoromethanesulfonyl) imide, N-methyl-N-propylpyrrolidinium bis(trifluoromethylsulfonyl) amide, Trioctylmethylammonium bis(trifluoromethylsulfonyl)imide.

Oxides of metals such as Li, Al, Ti, Mo, Ta, Nb, V, Mn, etc.(for example LiTaO₃, LiNbO₃, Li₂OAl₂O₃ Li₂O₅Al₂O₃, Li₂MoO₄, LiMo₃O₈, Li₃Mn_{0.5}Nb₂O₇) and metal oxide systems (such as Li₂O—MnO—Nb₂O₅, Li₂O—MnO—Ta₂O₅, Li₂O—MgO—Nb₂O₅, Li₂O—MgO—V₂O₅) can be implanted into a carbon matrix of the electrode material of the invention.

According to the invention, pore sizes can be regulated by using chemical reactions of active gases (oxygen, hydrogen, ethylene, etc.) with the walls of a carbon matrix, such as a CNT tape, film, fibers, etc.

Because of these reactions, carbon can pass into a gaseous state from the pore walls in the form of chemical compounds (CO, CH4, CH2, CO2, C2H4, etc.), or, conversely, can precipitate from the gas on the pore walls.

If carbon leaves the pore walls, then the pore size increases, and if carbon precipitates, then the pores decrease. Thus, we can optimize the porosity of the matrix for the required purposes.

Let us consider specific reactions of interaction with pore walls.

More specifically, inside the pores, oxygen and hydrogen interact with carbon in the following manner:

O₂+C=CO₂ (1)

2H₂+2C=C₂H₄ (2)

2H₂+C=CH₄ (3)

CO₂+C=2CO (4)

The resulting gases are removed by evacuation. In fact, these are reduction-oxidation (redox) types of reactions.

By selecting the conditions for the chemical interaction of the aforementioned components, it is possible to achieve optimal pore sizes due to their increase or decrease. Optimum pore sizes are understood to mean sizes that will make it possible to obtain batteries with improved characteristics.

For example, reactions (2) and (3) can go both ways. The reactions can be combined. For example, reactions (2) and (3) can be used for precipitation, and reaction (1) and (4) for increase of the pores. According to this principle, either reaction or a group of reactions can be combined with another reaction or another combination of the reactions.

To evaluate the effectiveness of the obtained pore size distribution, it is necessary to manufacture DC elements such as LIBs and EDLCs, which include electrodes made according to the invention.

For this purpose, the pores of the electrodes are impregnated with solutions of organic salts of Li, Ti, Mo, Ta, V, Mn, etc., in an oxygen-containing medium. Such a process causes formation and precipitation of oxides of Li, Ti, Mo, Ta, V, and Mn on the walls of the pores.

The oxide formation reactions may be exemplified by the following processes:

4Ta(CH₂C₆H₅)₄+145O₂=2Ta₂O₅+112CO₂+56H₂O

Ti[OCH(CH₃)₂]₄+18O₂=TiO₂+12CO₂+14H₂O,

(C₅H₅)₂Mo₂(CO)₆+18O₂=Mo₂O₅+16CO₂+5H₂O

(C₅H₅)₂Mo₂(CO)₆+O₂=2MoO₃+CO₂+H₂O

2V(CO)₆+17O₂=2V₂O₅+24CO₂
or the like.

An additive, such as poly (tetrafluoroethylene) (PTFE) or poly (vinylidenedifluoride) (PVDF) can be added at the impregnation stage.

The impregnation with an electrolyte is carried out at 20 to 60° C. and under a pressure of 1 atm.

A non-aqueous solution of an electrolyte may be represented, e.g., by 1-methyl-1-propylpiperidinium bis(trifluoromethanesulfonyl) imide, N-methyl-N-propylpyrrolidinium bis(trifluoromethylsulfonyl) amide, Trioctylmethylammonium bis(trifluoromethylsulfonyl)imide.

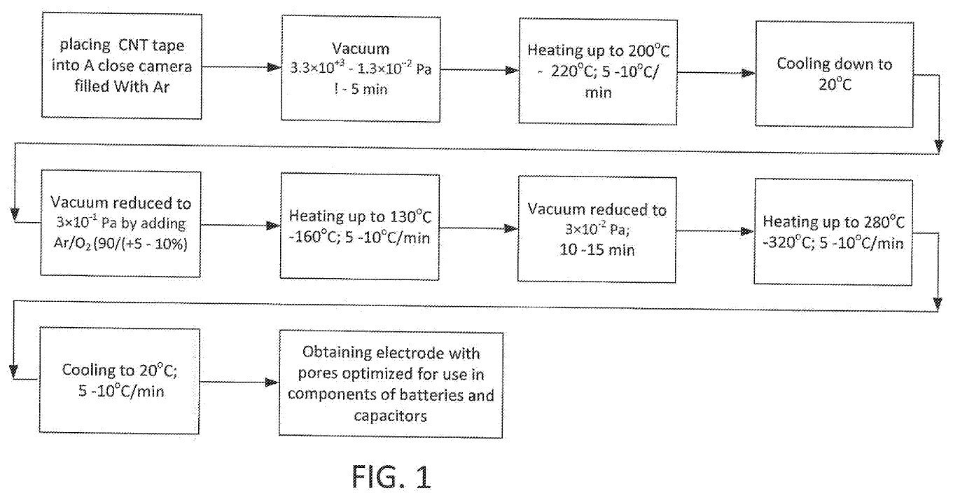

A flowchart of an exemplary sequence of CNT tape treatment operations in accordance with the method of the invention is shown in FIG. 1.

The electrode material of ion-lithium batteries obtained with the method of the invention had differential pore volume distribution, which was optimized as compared to a non-treated material by 20-40%.

### EXAMPLES

According to the invention, samples prepared from CNT DexMat tapes having a width of 10 to 20 mm, a thickness of 20 to 60 microns, and a length of 10 to 60 mm were subjected to various processes of vacuum gas heating-cooling treatment prior to subsequent steps of the aforementioned impregnations. The heating-cooling treatment conditions were selected from obtaining electrode materials of predetermined porosities, wherein the porosity was evaluated in terms of differential pore volume distribution.

### Example 1

Initial CNT tape samples were subjected to the following treatment:

1. Exposure to vacuum from 3.3×10³ to 1.3×10⁻² Pa for 1 to 5 minutes.

2. Heating with a rate of 10° C./min to a temperature of 200° C.

3. Cooling to 20° C.

4. Increase of pressure from 1.3×10⁻² Pa vacuum to 3×10⁻¹ Pa by adding an argon/hydrogen mixture (95-90% Ar/−10% H₂).

5. Heating with a rate of 10° C./min to a temperature of 150° C.

6. Pumping to vacuum from 3.3×10³ to 1.3×10⁻² Pa for 10 minutes.

7. Heating to 300° C. at the rate of 10° C./min.

8. Cooling to 20° C. at a rate of 5° C./min.

The differential pore volume was increased as compared to the non-treated material by 25%.

### Example 2

Initial CNT tape samples were subjected to the following treatment:

1. Exposure to vacuum from 3.3×10³ to 1.3×10⁻² Pa for 1 to 5 minutes.

2. Heating at a rate of 10° C./min to a temperature of 200° C.

3. Cooling to 20° C.

4. Increase of pressure from 1.3×10⁻² Pa vacuum to 3×10⁻¹ Pa by adding an argon/oxygen mixture (99-98% Ar/−1-2% O₂).

5. Heating at a rate of 10° C./min to a temperature of 100° C.

6. Pumping to vacuum from 3.3×10⁻¹ to 1.3×10⁻² Pa for 10 minutes.

7. Heating to 500° C. at a rate of 10° C./min.

8. Cooling to 20° C. at a rate of 20° C./min.

The differential pore volume was increased as compared to the pretreatment material by 35% .

### Example 3

Initial CNT tape samples were subjected to the following treatment:

1. Exposure in vacuum from 3.3×10³ to 1.3×10⁻² Pa for 1 to 5 minutes.

2. Heating at a rate of 10° C./min to a temperature of 200° C.

3. Cooling to 20° C.

4. Increase of pressure from 1.3×10⁻² Pa vacuum to 3×10⁻¹ Pa by adding an argon/carbon dioxide (95-98% Ar/5-2% CO₂).

5. Heating at a rate of 10° C./min to a temperature of 200° C.

6. Pumping to vacuum from 3.3×10³ to 1.3×10⁻² Pa for 10 minutes.

7. Heating to 600° C. at a rate of 10° C./min.

8. Cooling to 20° C. at a rate of 10° C./min.

The differential pore volume was increased as compared to the pretreatment material by 35%.

### Example 4

Initial CNT tape samples were subjected to the following treatment:

1. Exposure in vacuum from 3.3×10³ to 1.3×10⁻² Pa for 1 to 5 minutes.

2. Heating at a rate of 10° C./min to a temperature of 200° C.

3. Cooling to 20° C.

4. Increase of pressure from 3×10⁻² Pa vacuum to 3×10⁻¹ Pa by adding an argon/ethylene dioxide (92-95% Ar/8-5% C₂H₄).

5. Heating 10° C./min to a temperature of 400° C.

6. Pumping to vacuum from 3.3×10⁻¹ to 1.3×10⁻² Pa for 10 minutes.

7. Heating to 600° C. at the rate of 10° C./min.

8. Cooling to 20° C. at a rate of 5° C./min.

The differential pore volume was increased as compared to the pretreatment material by 27%.

### Example 5

Initial CNT tape samples were subjected to the following treatment:

1. Exposure in vacuum from 3.3×10³ to 1.3×10⁻² Pa for 1 to 5 minutes.

2. Heating at a rate of 10° C./min to a temperature of 300° C.

3. Cooling to 20° C.

4. Decrease of pressure from 3×10³ Pa vacuum to 3×10⁻² Pa by adding an argon/oxygen (99-98Ar/1-2% O₂).

5. Increase the pressure by adding water to vacuum of 3.3×10⁻¹;

6. Heating at a rate of 10° C./min to a temperature of 200° C.

7. Increase of vacuum from 3.3×10⁻¹to 3.3×10⁻² during 10 min.

8. Heating to 250° C. at the rate of 10° C./min.

9. Cooling to 20° C. at a rate of 5° C./min.

The differential pore volume was optimized as compared to the pretreatment material by 35% .

By selecting the conditions for the chemical interaction of active gaseous components with carbon on the pore walls of the carbon matrix, it is possible to achieve optimal pore sizes due to their increase or decrease.

The invention has been described with reference to specific examples of the proposed method. It is understood, however, that the aforementioned examples should not be construed as limiting the use of the invention and that any changes and modifications are possible without deviation from the scope of the attached patent claims. For example, gaseous components other than indicated but reactive with the carbon of the pores can be used in the proposed method. Steps of heating, cooling, pressurization and depressurization can be used in combinations and sequences other than those described in the specification.

1. A method of manufacturing electrode materials for use as electrodes of batteries and/or capacitors, the method comprising:
providing a fluid-penetrable porous carbon material having pores of initial sizes; and
increasing or decreasing the initial sizes of the pores by subjecting the fluid-penetrable porous carbon material to multiple preselected steps of chemical interaction of the carbon on surfaces of the initial pores with fluid media, which are passed through the initial pores of the fluid-penetrable porous carbon material, the chemical interaction resulting in formation of gaseous reaction products or solid reaction products, wherein the initial sizes of the pores are increased when the gaseous reaction products exit the pores and decreased when the solid reaction products precipitate on the surfaces of the pores.

2. The method of claim 1, wherein the fluid media is selected from gases and liquids, and wherein the multiple preselected steps of chemical interaction comprise the group consisting of heating, cooling, pressurizing, and depressurizing, the gases and liquids being used in various combination, and the multiple preselected steps being combined in various combinations and sequences, the media and the steps of chemical interaction being selected based on providing the batteries and/or capacitors, in which the electrodes are to be used, with the best possible performance characteristics.

3. The method of claim 2, wherein the fluid-penetrable porous carbon material is a carbon nanotube tape.

4. The method of claim 3, wherein gases are selected from oxygen, hydrogen, ethylene, carbon monoxide, ethylene dioxide, and carbon dioxide in a mixture with an inert gas.

5. The method of claim 4, wherein, in the multiple preselected steps, a temperature is used in the range of 20° C. to 600° C. and a pressure, is selected in the range of 3.3×10³ Pa to 1.3×10⁻² Pa.

6. The method of claim 5, wherein the multiple preselected steps for treating the fluid-penetrable porous carbon material are the following:
Exposing to a vacuum from 3.3×10³ Pa to 1.3×10⁻² Pa for 1 to 5 minutes;
Heating with a rate of 10° C./min to a temperature of 200° C.;
cooling to 20° C.
increasing the pressure from 1.3×10⁻² Pa to 3×10⁻¹ Pa by adding an argon/hydrogen mixture (95-90% Ar/−10% H₂);
heating with a rate of 10° C./min to a temperature of 150° C.;
decreasing the pressure from 3.3×10³ Pa to 1.3×10⁻² Pa for 10 minutes;
heating to 300° C. at a rate of 10° C./min; and
cooling to 20° C. at a rate of 5° C./min.

7. The method of claim 5, wherein the multiple preselected steps for treating the fluid-penetrable porous carbon material are the following:
exposing to vacuum from 3.3×10³ Pa to 1.3×10⁻² Pa for 1 to 5 minutes;
heating at a rate of 10° C./min to a temperature of 200° C.;
cooling to 20° C.;
increasing the pressure from 1.3×10⁻² Pa vacuum to 3×10⁻¹ Pa by adding an argon/oxygen mixture (99-98% Ar/−1-2% O₂);
heating at a rate of 10° C./min to a temperature of 100° C.;
decreasing the pressure to vacuum from 3.3×10⁻¹ to 1.3×10⁻² Pa for 10 minutes;
heating to 500° C. at a rate of 10° C./min; and
cooling to 20° C. at a rate of 20° C./min.

8. The method of claim 5, wherein the multiple preselected steps for treating the fluid-penetrable porous carbon material are the following:
exposing to vacuum from 3.3×10³ Pa to 1.3×10⁻² Pa for 1 to 5 minutes;
heating at a rate of 10° C./min to a temperature of 200° C.;
cooling to 20° C.;
increasing the pressure from 1.3×10⁻² Pa vacuum to 3×10⁻¹ Pa by adding an argon/carbon dioxide (95-98% Ar/5-2% CO₂);
heating at a rate of 10° C./min to a temperature of 200° C.;
increasing vacuum from 3.3×10³ Pa to 1.3×10⁻² Pa for 10 minutes;
heating to 600° C. at a rate of 10° C./min; and
cooling to 20° C. at a rate of 10° C./min.

9. The method of claim 5, wherein the multiple preselected steps for treating the fluid-penetrable porous carbon material are the following:
exposing to vacuum from 3.3×10³ Pa to 1.3×10⁻² Pa for 1 to 5 minutes;
heating at a rate of 10° C./min to a temperature of 200° C.;
cooling to 20° C.;
Increasing the pressure from 3×10⁻² Pa vacuum to 3×10⁻¹ Pa by adding an argon/ethylene dioxide (92-95% Ar/8-5% C₂H₄).
heating at a rate of 10° C./min to a temperature of 400° C.;
decreasing the pressure from 3.3×10⁻¹ Pa to 1.3×10⁻² Pa for 10 minutes;
heating to 600° C. at a rate of 10° C./min; and
cooling to 20° C. at a rate of 5° C./min.

10. The method of claim 5, wherein the multiple preselected steps for treating the fluid-penetrable porous carbon material are the following:
exposing to vacuum from 3.3×10³ Pa to 1.3×10⁻² Pa for 1 to 5 minutes;
heating at a rate of 10° C./min to a temperature of 300° C.;
cooling to 20° C.;
decreasing the pressure from 3×10³ Pa vacuum to 3×10⁻² Pa by adding an argon/oxygen (99-98Ar/1-2% O₂);
Increasing the pressure to vacuum of 3.3×10⁻¹Pa by adding water;
heating at a rate of 10° C./min to a temperature of 200° C.;
decreasing the pressure from 3.3×10⁻¹ Pa to 3.3×10⁻² Pa during 10 min;
heating to 250° C. at a rate of 10° C./min; and
cooling to 20° C. at a rate of 5° C./min.
